(19) United States
(12) Patent Application Publication
(10) Pub. No.: US 2004/0137223 A1
(43) Pub. Date: Jul. 15, 2004

(54) Self-adhesive surface protection film

(76) Inventors: Markus Hamulski, Gronau-Epe (DE); Andreas Hagemann, Dulmen (DE)

Correspondence Address: WILLIAM COLLARD, COLLARD & ROE, P.C., 1077 NORTHERN BOULEVARD, ROSLYN, NY, 11576, US

(21) Appl. No.: 10/628,799

(22) Filed: Jul. 28, 2003

(30) Foreign Application Priority Data
Jul. 31, 2002 (DE) 102 35 021.3

(51) Int. Cl. B32B 15/04

(52) U.S. Cl. 428/343

(57) ABSTRACT

A self-adhesive surface protection film, particularly for covering painted sheet metal and high-gloss sheet metal made of aluminum or stainless steel, has a layered laminate containing at least a carrier layer and an adhesive layer. The layered laminate is produced by means of coextrusion and the coextruded adhesive layer is based on polyisobutylene and/or on a styrene block copolymer.

### CROSS REFERENCE TO RELATED APPLICATIONS

Applicants claim priority under 35 U.S.C. §119 of German Application No. 102 35 021.3 filed Jul. 31, 2002.

### BACKGROUND OF THE INVENTION

1. Field of the Invention

The present invention relates to a self-adhesive surface protection film, particularly for covering painted sheet metal and high-gloss sheet metal made of aluminum or stainless steel, having a layered laminate containing at least a carrier layer and an adhesive layer.

2. The Prior Art

Polyolefin films that are coated with an acrylate adhesive or with natural rubber or latex are known. The acrylate adhesive has a number of disadvantages. In part, it leaves visible residues on smooth surfaces, it is relatively moisture-sensitive unless special measures are taken, and it possesses an adhesive strength that is dependent on the surface chemistry of the contact surface and increases at higher temperatures. Because of quality variations, natural rubber often demonstrates great variations in its adhesive strength, and is very non-resistant to aging unless appropriate stabilization is provided. Acrylate adhesive and natural rubber are processed as a dispersion or emulsion. Therefore, two work steps are required for the production of a surface protection film, namely film extrusion and subsequent coating with an adhesive. This two-step method is complicated.

Furthermore, coextruded adhesive films having an adhesive layer on the basis of an ethylene/vinyl acetate rubber are known from DE 199 23 780. These films are suitable for use only as surface protection films on car paints, because the adhesive strength on other surfaces is greatly dependent on the physical and chemical properties of the contact surface, in each instance, and increases with increasing temperature. When this film is released from shiny aluminum and stainless steel surfaces, disruptive residues in the form of a milky haze remain. In the case of painted surfaces with polyurethane paint, and on plastic surfaces, permanent adherence often occurs after severe heat stress. Finally, the bonding between the adhesive layer and the carrier of the adhesive film is also problematic. At higher temperatures, layer separation is occasionally observed.

### SUMMARY OF THE INVENTION

The object of the invention is to provide a self-adhesive surface protection film that can be produced in a simple manner, by means of coextrusion, and that is suitable for temporary protection of painted sheet metal as well as high-gloss sheet metal made of aluminum or stainless steel.

These and other objects are achieved in accordance with the invention by a self-adhesive surface protection film, particularly for covering painted sheet metal and high-gloss sheet metal made of aluminum or stainless steel. The film has a layered laminate containing at least a carrier layer and an adhesive layer. The layered laminate is produced by means of coextrusion and the coextruded adhesive layer is based on polyisobutylene and/or on a styrene block copolymer. Suitable polystyrene block copolymers are styrene/isoprene/styrene (SIS), styrene/ethylene/butylene/styrene (SEBS), styrene/ethylene/propylene/styrene (SEPS), styrene/butadiene/styrene (SBS) copolymers or mixtures of the stated copolymers. Styrene block copolymers or polyisobutylene may be used as an adhesive layer in their pure form. Preferably, however, a mixture with additives is produced, thereby modifying the adhesive strength and the removal behavior. Polyolefins are particularly suitable for such mixtures, particularly polyethylene and polypropylene, as well as amorphous poly alpha olefins (APAO) and tackifier resins.

The surface protection film according to the invention is produced in a single process step, by means of coextrusion. The invention is based on the recognition that styrene block copolymers and polyisobutylene can be used as pressure-sensitive adhesive layers without being plastified with oils or resins, and can be processed by means of coextrusion. When using SIS or SBS copolymers, these should have a di-block content (SI) or (SB) of less than 15% by weight. For uses of the surface protection film according to the invention on high-gloss sheet metal made of aluminum or stainless steel, the di-block content should be less than 1% by weight.

Preferably, the adhesive layer is adjusted so that the peel strength after storage at room temperature for 24 hours is between 0.15 N/cm and 3.5 N/cm (measured according to AFERA 4001). According to a preferred embodiment, the adhesive layer contains a mixture of an SIS block copolymer and polyethylene. By means of the mixture with polyethylene, which can be added in amounts of up to 60% by weight, the adhesive strength of the adhesive layer can be adjusted in a variable manner. In another preferred embodiment, the adhesive layer contains a mixture of SEBS copolymers and amorphous poly alpha olefins. With this adhesive formulation, a surface protection film is obtained that has a very soft pull-off behavior and can be universally used. The adhesive strengths on plastic, such as polycarbonate (PC) and polymethylmethacrylate (PMMA), as well as on painted sheet metal using polyethylene terephthalate (PET), polyurethane (PU), polyvinylidene fluoride (PVDF), polyethylene (PE) paint are on the same adhesive strength level, in each instance.

Polyolefins can be used as the carrier layer. A bonding agent layer may be provided between the carrier layer. The carrier layer may contain an ultraviolet (UV) light stabilizer.

Preferably, the carrier layer has a thickness of 20 to 80 μm. The coextruded adhesive layer preferably has a thickness between 4 and 20 μm.

In a further embodiment, the coextruded layered laminate has an additional release layer on the side of the carrier layer that faces away from the adhesive layer. The release layer causes separation between the film layers when the surface protection film is rolled up on a roll. It can contain talcum, chalk, silicic acid, polyamide wax, or mixtures of these substances. A release layer having a micro-embossed surface produced by an embossing roller is also advantageous.

### DETAILED DESCRIPTION OF PREFERRED EMBODIMENTS

The surface protection film according to the invention is characterized by good adhesion on surfaces such as glass, ceramic, steel, polycarbonate, acrylic glass, and the like. A particularly preferred use is as a surface protection film for painted sheet metal and for high-gloss sheet metal made of aluminum or stainless steel, which can be present, for example, in the form of metal coils, sheet-metal panels, semi-finished products, or finished products. The surface protection film according to the invention can be easily and softly pulled away from the surfaces, without leaving any residue. It can be produced in a single process step, by means of coextrusion, in simple and cost-effective manner.

### EXAMPLE

The following film formulation merely serves to illustrate the structure and the adhesive formulation of a surface protection film according to the invention having a layered laminate produced by means of coextrusion.

Release Layer: 7 μm

50 wt. % low density polyethylene (PE-LD) with a high melt flow index (MFI) (15 g/10 min)

30 wt. % PE anti-block batch containing 65 wt. % silica

20 wt. % PE/PP talcum batch containing 40 wt. % talcum

Carrier Layer: 38 μm

60 wt. % linear polyethylene of medium density (PE-LMD)

40 wt. % high density polyethylene (PE-HD)

Bonding Agent Layer: 7 μm

100 wt. % ethylene vinyl acetate containing 28 wt. % vinyl acetate

Adhesive Layer: 8 μm

60 wt. % SIS

40 wt. % low density polyethylene (PE-LD)

While only a few embodiments of the present invention have been shown and described, it is to be understood that many changes and modifications may be made thereunto without departing from the spirit and scope of the invention as defined in the appended claims.

What is claimed is:

1. Self-adhesive surface protection film comprising a layered laminate produced by coextrusion, said laminate comprising:
(a) a carrier layer and
(b) an adhesive layer comprising a member selected from the group consisting of polyisobutylene, a styrene block copolymer, and mixtures thereof.

2. The surface protection film according to claim 1 wherein said adhesive layer comprises a styrene block copolymer selected from the group consisting of:
a styrene/isoprene/styrene (SIS) copolymer,
a styrene/ethylene/butylene/styrene (SEBS) copolymer,
a styrene/ethylene/propylene/styrene (SEPS) copolymer, and
a styrene/butadiene/styrene (SBS) copolymer, or
a mixture of one or more styrene block copolymers selected from said group.

3. The surface protection film according to claim 1 wherein said adhesive layer comprises a styrene block copolymer selected from the group consisting of:
a styrene/isoprene/styrene (SIS) copolymer, and
a styrene/butadiene/styrene (SBS) copolymer, and
having a di-block content of less than 15% by weight.

4. The surface protection film according to claim 3, wherein the di-block content is less than 1% by weight.

5. The surface protection film according to claim 1 wherein said film has an adhesive strength after storage at room temperature for 24 hours of between 0.15 N/cm and 3.5 N/cm.

6. The surface protection film according to claim 1, wherein said adhesive layer comprises a mixture of a styrene block copolymer and polyolefins.

7. The surface protection film according to claim 1, wherein said adhesive layer comprises a mixture of styrene block copolymer and amorphous poly alpha olefins.

8. The surface protection film according to claim 1, wherein said carrier layer is made from a polyolefin.

9. The surface protection film according to claim 1, further comprising a bonding agent layer arranged between said carrier layer and said adhesive layer.

10. The surface protection film according to claim 1, wherein said carrier layer has a thickness of 20 to 80 μm and said adhesive layer has a thickness between 4 and 20 μm.

11. The surface protection film according to claim 1, wherein said layered laminate produced by coextrusion has a release layer on a side of said carrier layer facing away from said adhesive layer.

12. The surface protection film according to claim 11, wherein said release layer comprises a member selected from the group consisting of talcum, chalk, silicic acid, polyamide wax, and mixtures thereof.

13. The surface protection film according to claim 11, wherein said release layer has a micro-embossed surface produced by an embossing roller.
